(19) United States
(12) Patent Application Publication
(10) Pub. No.: US 2008/0215640 A1
(43) Pub. Date: Sep. 4, 2008

(54) METHOD OF PROCESSING APARTMENT TENANT STATUS INFORMATION

(75) Inventors: Eric W. Hartz, Atlanta, GA (US); Harold M. Solomon, Atlanta, GA (US); Peter Hoeve, Roswell, GA (US); Evan D. Jennings, Atlanta, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: RENT BUREAU, LLC, Atlanta, GA (US)

(21) Appl. No.: 11/680,955

(22) Filed: Mar. 1, 2007

(51) Int. Cl. G06F 17/30; G06F 12/02

(52) U.S. Cl. 707/204; 707/2

(57) ABSTRACT

In a method of processing tenant information, a first set of tenant history data, in a first format, is pushed from a first apartment rental management organization database to a central server. A second set of tenant history data, in a second format different from the first format, is pushed from a second apartment rental management organization database to the central server. Selected elements from the first set of tenant history data and the second set of tenant history data are assembled into a central database in a standard format. The central database is stored on the central server. Tenant history data is provided from the central database to a selected apartment rental management organization.

### BACKGROUND OF THE INVENTION

1. Field of the Invention

The present invention relates to financial systems and, more specifically, to a system of correlating data from a plurality of rental management organizations.

2. Description of the Prior Art

Apartment owners lose billions of dollars each year from skips, NSFs, bad debt and evictions. Also, because they are renting rather that buying real estate, many tenants are not building a credit history even though they may have a strong rent payment history.

Management organizations collect, organize and report data relating to individuals engaging in credit-based transactions. For example, credit bureaus receive information for various lenders and the like regarding the credit histories of individuals and certain business entities.

A credit history or credit report is a record of an individual's or company's history of borrowing and repaying. It typically includes information about late payments and bankruptcy. When a customer fills out an application for credit from a bank, store or credit card company, the information is forwarded to a credit bureau, along with constant updates on the status of the customer's credit accounts, address changes or any relevant information.

Credit history information is used by lenders, such as banks and credit card companies, to determine an individual's credit worthiness and, thus, to make lending decisions. Such decisions could include whether to extend credit to an individual and on what terms.

In the apartment rental industry, landlords are typically concerned about the likelihood of prospective tenants making rental payments in a timely fashion. Late payments by a tenant can impose a substantial financial burden on a landlord and the cost of instituting an eviction and renting a recently-vacated apartment can be quite expensive.

Currently, there are several apartment rental credit reporting organizations. However, they are either internal to specific apartment rental companies or are subscriber-based systems. The internal systems cannot take advantage of the data accumulated by competing companies and the subscriber-based systems require apartment company subscribers to format their reporting data into a specific data format. It is difficult for companies with internal systems to convert to the subscriber-bases systems since they would have to convert all of their data from their internal data formats to the format used by the subscriber-based system.

Therefore, there is a need for an apartment rental reporting system that allows apartment rental organizations to maintain data in their internal format, while sharing information with other organizations.

### SUMMARY OF THE INVENTION

The disadvantages of the prior art are overcome by the present invention which, in one aspect, is a method of processing tenant information, in which a first set of tenant history data, in a first format, is pushed from a first apartment rental management organization database to a central server. A second set of tenant history data, in a second format different from the first format, is pushed from a second apartment rental management organization database to the central server. Selected elements from the first set of tenant history data and the second set of tenant history data are assembled into a central database in a standard format. The central database is stored on the central server. Tenant history data is provided from the central database to a selected apartment rental management (or resident screening) organization.

In another aspect, the invention is a method of assembling tenant history data from a plurality of rental management organizations, in which a set of tenant history data for each of the rental management organizations is received periodically. At least one first set of tenant history data is in a first format and at least one second set of tenant history data is in a second format, different from the first format. The first set is extracted with a first extraction program that selects relevant data from the first set. The second set is extracted with a second extraction program that selects relevant data from the second set. The selected data from the first set is bundled with information regarding the first format, thereby creating bundled first set data. The selected data from the second set is bundled with information regarding the second format, thereby creating bundled second set data. The bundled first set data and the bundled second set data are sent to a secure server. The selected data from the bundled first set data and the bundled second set data are mapped into a central database. A request from a requesting rental management organization for a selected subset of data regarding a selected tenant is responded to by extracting tenant-specific data regarding the tenant from the central database and bundling the tenant-specific data along with format data corresponding to a format desired by the requesting rental-organization into a bundled data package. The bundled data package is transmitted to the rental management organization.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of the relationship between computers used in one embodiment.

FIG. 2 is a schematic diagram showing manipulation of data from various organizations.

FIG. 3 is a block diagram showing a data import scheme.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

Also, as used herein, “rental management organization” includes rental organization, screening organization or scoring organization.

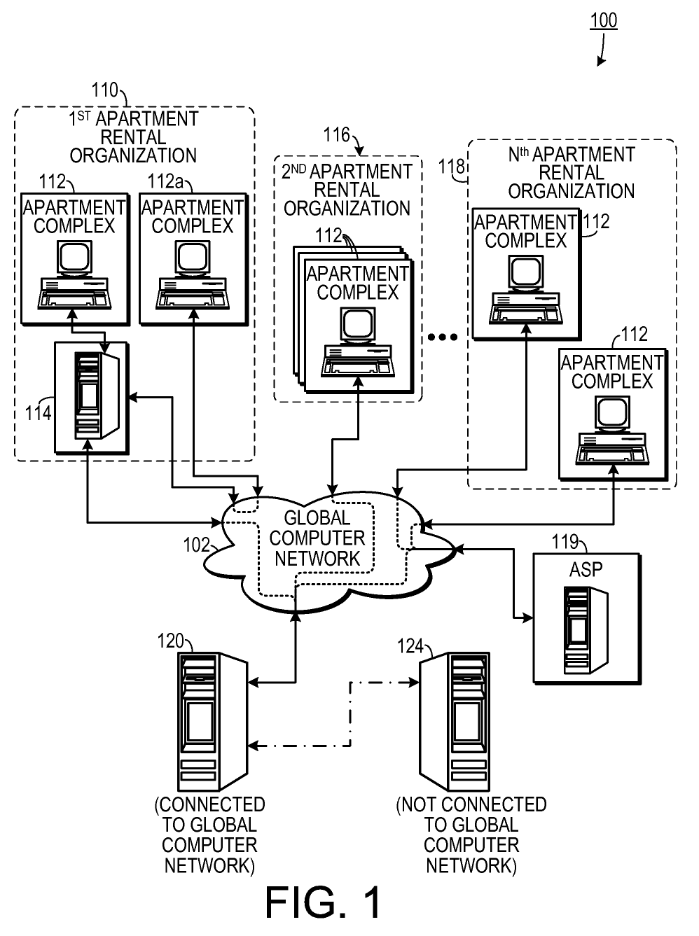

As shown in FIG. 1, one embodiment is a system 100 in which a plurality of different apartment rental management organizations communicate with a central server 120 via a global computer network 102 (such as the Internet) to facilitate exchange of apartment rental credit information. On a periodic (such as nightly) basis, each of the apartment rental management organizations push tenant payment data to the central server 120, which sends the data to a secure server 124 that is not connected to the global computer network. The rental management organizations typically do not use a single standard data format. Therefore, the information is converted from the data format used by each of the rental management organizations to a standard format prior to being stored in the central server 120.

The apartment rental management organizations could communicate with the central server in one of several ways. For example, in one embodiment, one apartment rental organization 110 includes a self-hosted application, in which a plurality of apartment complexes each have a computer 112 (or other network browsing device) that communicates apartment rental credit information to a rental organization-maintained server 114, which is in communication with the global computer network 102. (The individual computers 112 could be hard-wired to communicate directly with the server 114 or, as in the case of computer 112a, they could communicate with the server via the global computer network 102.) In another embodiment, with another apartment rental organization 116 each apartment complex has a computer 112 that communicates directly with the central server 120 via the global computer network 102. In another embodiment, yet another apartment rental organization 118 provides information from its computers 112 to a server 119 managed by an application service provider (ASP). The ASP provides credit reporting software services to one or more apartment rental organizations and maintains the data of each on a separate part of the server 119. The ASP server communicates the apartment rental credit information for the apartment rental organization 118 to the central server 120 via the global computer network 102.

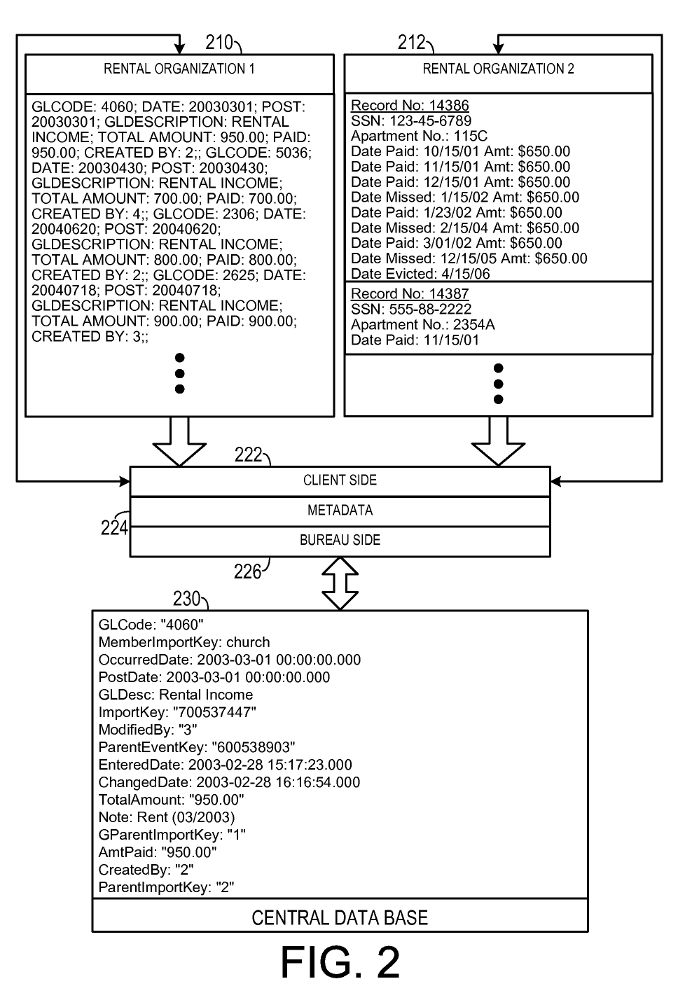

One method of standardizing data is shown in FIG. 2, in which a first rental organization 210 and a second rental organization 212 each maintain data on the rental payment history of their respective tenants. The rental organization 210 and 212 also maintains their data in different formats and in databases with a different structure. On a periodic basis on the client side 222 an extraction program selects all relevant data from the rental organization's source database and prepares the data for a destination database. The extraction program also extracts the format of the selected source data from the source database. The result of the data extract extraction is metadata 224, which is bundled together with the format information compressed, encrypted and sent, using a secure hypertext transfer protocol to a secure server (item 120 in FIG. 1).

An extraction program is written only once for a given source database type (examples of currently-used database types used in the rental industry include: Yardi®, MRI®, AMSI®, Rent Roll®). This extraction program selects the relevant data from the source database to generate the metadata.

On the bureau side 226, which is physically separated from the client side 222, all data is immediately removed from the secured server (item 120 in FIG. 1) to a server (item 124 in FIG. 1) not connected to the global computer network (item 102 in FIG. 1). The extracted data received by the bureau is unencrypted and uncompressed into data and format files of a bureau standard, using a standard language (such as YAML).

A database type driven map, prepared once for each database type, is used by the import process to parse the extracted data and translate the source database field names and related data into the destination database table and field structure. The map also contains exception handling logic to allow for variability in data use for databases of the same type. Errors are handled for data that is outside predefined limits at this import stage with an exception handling mechanism.

Once the import is complete, the extracted data is part of the target database 230 and is available for production use. Thus, the data is extracted from variously structured databases that contain similar and related information. Relevant information is identified and the data elements are entered into one unified data repository 230.

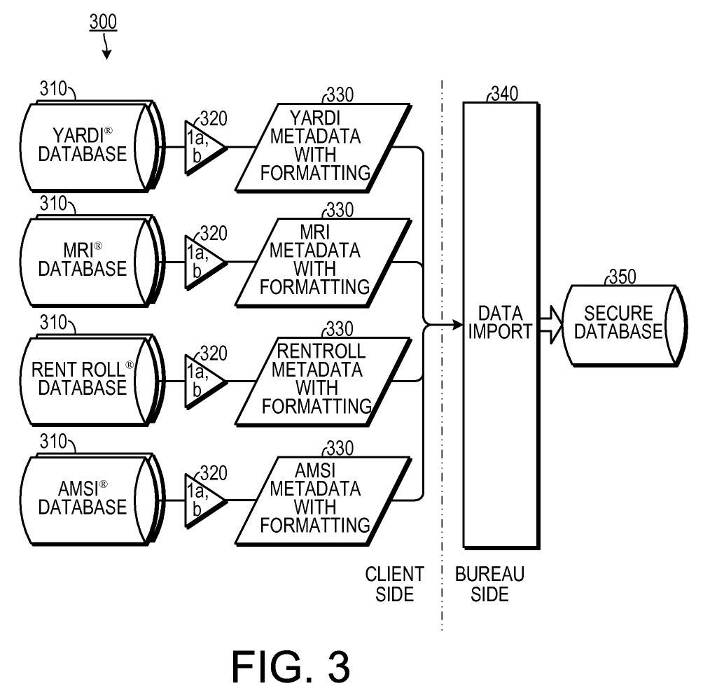

One method of extracting data is shown in FIG. 3, in which the rental organization databases 310 are maintained on the client side. A data push program 320 at each participating rental organization periodically pushes the metadata 330 from the rental organization databases 310. The metadata 330, along with the relevant formatting information, is transmitted to the bureau side to a data import engine 340 that combines the metadata into a comprehensive and unified rental information database 350.

The information may then be transmitted back to the apartment rental organizations on an as-needed basis. For example, when a prospective tenant applies for a lease with an apartment rental organization, that organization sends identifying information to the bureau, or bureaus, and retrieves a rental payment history report from the bureau. An inquiry from an apartment company starts with an operator keying applicant data into a screening service application. The screening service passes the inquiry to the bureau. The bureau answers the query back to the screening service. A leasing consultant uses that result to accept or decline the applicant. The rental payment report is delivered in the format and structure that the rental organization uses. This system has the advantage of providing different rental organizations with payment history data that is acquired from several other apartment rental organizations and to participate in reporting payment histories of tenants.

In one embodiment, the system provides apartment owners and managers with real time, accurate and free rental payment histories of tenant applicants to be used as an additional predictive source for screening. Periodically (such as every 24 hours), the system collects rental payment information from owners and managers in its member network without any impact to operations centrally or at the property. This data is immediately integrated and made available to members through the system's secure, proprietary database 350. Also, this data is accessible directly or integrated through current tenant screening solutions. The system collects updated information from the many apartments in a member network. The system allows member rental organizations to provide and access rental information without imposing any formatting requirements. The data is automatically updated and kept current. Thus, accurate information about potential renters is immediately available to members through their existing potential tenant screening systems.

The system collects and reports rental histories by automatically extracting rental information from a multi-family development's existing software—without interfering with the current system and invisible to the owner or manager. The process works invisibly within an apartment complex or management company's software operations and is fully compatible with common industry applications. Non-members, once verified, can access the secure database 350 for a fee. The database of rental information is always available on the global computer network. Searching the data is quick and uncomplicated. Results are reported in an easy-to-understand format so that the information can be immediately used in making tenant decisions.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method, operable on a digital computer, of processing tenant information, comprising the steps of:
a. pushing a first set of tenant history data, in a first format, from a first apartment rental management organization database to a central server;
b. pushing a second set of tenant history data, in a second format different from the first format, from a second apartment rental management organization database to the central server;
c. assembling selected elements from the first set of tenant history data and the second set of tenant history data into a central database in a standard format and storing the central database on the central server; and
d. providing tenant history data from the central database to a selected apartment rental management organization.

2. The method of claim 1, further comprising the step of providing selected metadata with the tenant history data from the central database when providing the tenant history data from the central database to the apartment rental management organization.

3. The method of claim 2, wherein the metadata includes formatting information.

4. The method of claim 1, wherein the tenant history data from the central database includes information about rental payments made by a tenant.

5. The method of claim 1, wherein the tenant history data from the central database includes information about late payments made by a tenant.

6. The method of claim 1, wherein the tenant history data from the central database includes information about lease defaults made by a tenant.

7. The method of claim 1, wherein the tenant history data from the central database includes information about an eviction of a tenant.

8. The method of claim 1, wherein the tenant history data from the central database is provided to the selected apartment rental management organization in exchange for the selected apartment rental management organization providing access to its tenant history data.

9. The method of claim 1, further comprising the step of providing the tenant history data to a credit bureau.

10. The method of claim 1, wherein the steps of pushing the first set of tenant history data and pushing the second set of tenant history data are repeated according to a predefined periodicity.

11. The method of claim 10, wherein the predefined periodicity is daily.

12. The method of claim 1, wherein the first set of tenant history data and the second set of tenant history data are each pushed from a property management system.

13. The method of claim 1, wherein the assembling step comprises the steps of:
a. searching the tenant history data for a selected set of field names; and
b. mapping data corresponding to each of the selected set of field names to a corresponding data structure in the central database.

14. A method, operable on a digital computer, of assembling tenant history data from a plurality of rental management organizations, comprising the steps of:
a. periodically receiving, via a global computer network, a set of tenant history data for each of the rental management organizations, wherein at least one first set of tenant history data is in a first format and at least one second set of tenant history data is in a second format, different from the first format;
b. extracting the first set with a first extraction program that selects relevant data from the first set and extracting the second set with a second extraction program that selects relevant data from the second set;
c. bundling the selected data from the first set with information regarding the first format, thereby creating bundled first set data, and bundling the selected data from the second set with information regarding the second format, thereby creating bundled second set data;
d. sending the bundled first set data and the bundled second set data to a secure server;
e. mapping the selected data from the bundled first set data and the bundled second set data into a central database;
f. responding to a request from a requesting rental management organization for a selected subset of data regarding a selected tenant by extracting tenant-specific data regarding the tenant from the central database and bundling the tenant-specific data along with format data corresponding to a format desired by the requesting rental-organization into a bundled data package; and
g. transmitting the bundled data package to the rental management organization.

15. The method of claim 14, wherein the extracting step further comprising the step of validating the selected data according a set of to predefined criteria.

16. The method of claim 14, wherein the tenant history data in the central database includes information about rental payments made by a tenant.

17. The method of claim 14, wherein the tenant history data in the central database includes information about late payments made by a tenant.

18. The method of claim 14, wherein the tenant history data in the central database includes information about lease defaults made by a tenant.

19. The method of claim 14, wherein the tenant history data in the central database includes information about an eviction of a tenant.

20. A system, operable on a digital computer, for processing tenant information, comprising the steps of:
a. means for pushing a first set of tenant history data, in a first format, from a first apartment rental management organization database to a central server;
b. means for pushing a second set of tenant history data, in a second format different from the first format, from a second apartment rental management organization database to the central server;
c. means for assembling selected elements from the first set of tenant history data and the second set of tenant history data into a central database in a standard format and storing the central database on the central server; and
d. means for providing tenant history data from the central database to a selected apartment rental management organization.
